(19) United States
(12) Patent Application Publication
(10) Pub. No.: US 2011/0256383 A1
(43) Pub. Date: Oct. 20, 2011

(54) POLYMER MATERIAL COMPRISING A POLYMER AND SILVER NANOPARTICLES DISPERSED HEREIN

(75) Inventors: Ayse Cochet, Koln (DE); Joachim Wagner, Koln (DE); Werner Jenninger, Koln (DE); Daniel Rudhardt, Koln (DE); Stefanie Eiden, Leverkusen (DE)

(73) Assignee: Bayer MaterialScience AG, Leverkusen (DE)

(21) Appl. No.: 13/072,990

(22) Filed: Mar. 28, 2011

(30) Foreign Application Priority Data
Apr. 1, 2010 (EP) 10003664.9

(51) Int. Cl. H01B 1/22; B32B 5/16

(52) U.S. Cl. 428/328; 252/514

(57) ABSTRACT

A polymer material according to the invention comprises a polymer and silver nanoparticles dispersed in the polymer. The silver nanoparticles may be obtained by reducing a silver salt in a dispersing agent in the presence of a dispersion stabilizer with a reducing agent, the dispersion stabilizer being selected from the group consisting of carboxylic acids having ≧1 to ≦6 carbon atoms, salts of carboxylic acids having ≧1 to ≦6 carbon atoms, sulfates and phosphates. Such a material is particularly suitable for use as an electrode. The invention furthermore relates to a method for producing such a polymer material and to a polymer laminar composite including a polymer substrate and a polymer material according to the invention

### FIELD OF THE INVENTION

The present invention relates to a polymer material, which comprises a polymer and silver nanoparticles dispersed in this polymer. Such a material is suitable in particular for use as an electrode: In particular, the present invention relates to a polymer material, which comprises a polymer and silver nanoparticles dispersed in the polymer, wherein the weight ratio of polymer material to silver nanoparticles is in a range from ≧10:90 to ≦50:50. The invention furthermore relates to a method for producing such a polymer material and to a polymer laminar composite comprising a polymer substrate and a polymer material according to the invention.

### BACKGROUND OF THE INVENTION

Many conductive particles/such as carbon black or metal nanoparticles, for example, can be used as additives in order as additives to impart electrically conductive properties to an insulating material. If the material obtained is both sufficiently conductive and flexible, it can be used as an extensible electrode in diverse applications of electromechanical conversion, such as for example actuator technology or generator technology.

The publication “Electrode structures in high strain actuator technology” by S. R. Ghaffarian et al., Journal of Optoelectronics and Advanced Materials 2007, 9, 3585-3591, for example, investigates electrode materials based on graphite powder, carbon-filled conductive lubricating grease, silver-filled conductive lubricating grease and carbon-filled conductive rubber.

Owing to its high electrical conductivity and its stability in respect of environmental conditions, the material silver is preferably used. The production of silver nanoparticles is known in principle. One route is the direct chemical reduction of dissolved metal ions in a liquid phase. The different variants of such methods differ mainly in the reaction conditions and the ways in which the reaction is performed. A further possibility is the synthesis of metal oxide nanoparticles which are reduced in a subsequent step.

To avoid an aggregation of the nanoparticles, polymeric dispersing agents can be added during their synthesis. Their presence is however riot always desirable if the nanoparticles obtained are to be incorporated into polymers. Furthermore, such dispersing agents reduce the electrical conductivity of the nanoparticle-containing systems, as a direct contact between the nanoparticles is inevitably reduced or suppressed.

US 2010/0040863 A1 proposes the addition of carboxylic acids to stabilize the nanoparticles without such auxiliary polymers. This patent application describes a method for producing carboxylic acid-stabilized silver nanoparticles wherein a mixture comprising a silver salt, a carboxylic acid and a tertiary amine is heated. The tertiary amine is used as both a solvent and a reducing agent. This application specifies furthermore that nanoparticles containing carboxylic acids having fewer than 12 carbon atoms are less readily soluble in organic solvents than those containing carboxylic acids having more than 12 carbon atoms. In the method described; however, in addition to the costs of the solvent, the unpleasant odor caused by the use of tertiary amines is apparent to those skilled in the art.

A chemical reduction of metal salts to form nanoparticles within a surface layer of a polymer is described in US 2009/0297829 A1. This application relates to a method of incorporating metal in the form of nanoparticles into the surface layer of a polymeric object and to the polymeric object obtained. The method involves the bringing into contact of at least a part of the object with a solvent blend containing (a) water and (b) a carrier according to R₁—[—O—(CH₂)ₙ]OR₂, wherein R₁ and R₂ independently of each other denote linear or branched C₁₋₈ alkyl, benzyl, benzoyl, phenyl or H. The value for n is 2 or 3 and m is 1 to 35. The mixture also Contains (c) a metal precursor and optionally (d) a leveling agent.

The bringing into contact takes place for a period of time, which is sufficient for at least a part of the metal precursor to infuse into the object, in order to obtain an object with a treated surface layer. The surface layer is then treated with a reducing agent in order to obtain metal in the form of nanoparticles.

WO 2005/079353 A2 discloses a nanoscale metal paste containing silver nanoparticles in the matrix, containing for example polyvinyl alcohol (PVA) or polyvinyl butyral (PVB) as a binder, wherein silver nitrate is reduced with sodium citrate and iron sulfate to produce the silver nanoparticles. The metal paste also includes dispersion stabilizers, which are intended to prevent an agglomeration of the silver nanoparticles. Fatty acids, fish oils, poly(diallyldimethylammonium chloride), polyacrylic acid and polystyrene sulfonate are mentioned as examples of such dispersion stabilizers. Such dispersion stabilizers sterically hinder the agglomeration of silver nanoparticles. As has already been described in Xia et al. in Adv. Mater., 2003,15, No. 9, 695-699, these steric dispersion stabilizers have the disadvantage that by covering the surface of the silver particles in the conductive coatings obtained they reduce the direct contact between the particles and hence the conductivity of the coating.

Methods which allow silver nanoparticles to be incorporated into polymers would still be desirable, however, wherein a higher conductivity as compared with the prior art should be achieved and maintained. Polymers containing such silver nanoparticles would be likewise desirable.

### SUMMARY OF THE INVENTION

The present invention provides a polymer material made from a polymer and silver nanoparticles dispersed in the polymer. The silver nanoparticles can be obtained by reducing a silver salt in a dispersing agent in the presence of a dispersion stabilizer with a reducing agent, the dispersion stabilizer being selected from the group comprising carboxylic acids having ≧1 to ≦6 carbon atoms, salts of carboxylic acids having ≧1 to ≦6 carbon atoms, sulfates and/or phosphates.

Such a material is suitable in particular for use as an electrode. The invention furthermore provides a method for producing such a polymer material and a polymer laminar composite comprising a polymer substrate and a polymer material according to the invention.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows the change in electrical resistance in the stress-strain curve;

FIG. 2 shows the change in specific conductivity with increasing strain; and

FIG. 3 shows a further change in specific conductivity with increasing strain.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a polymer material comprising a polymer and silver nanoparticles dispersed in the polymer. A polymer material is preferred which comprises a polymer and silver nanoparticles dispersed in the polymer, wherein the weight ratio of polymer material to silver nanoparticles is in a range from ≧10:90 to ≦50:50. If the silver content rises above 90 wt. %, the extensibility and tear strength of the polymer material falls sharply, while if the silver content drops below 50 wt. % the conductivity of the polymer material falls sharply. Below 70 wt. % Ag the conductivity starts to fall dramatically, and at 50 wt. % the conductivity is very low or no longer measurable.

The weight ratio of polymer to silver nanoparticles here is preferably in a range from ≧20:80 to ≦30:70, particularly preferably in a range from ≧40:60 to ≦45:55.

The silver nanoparticles may be obtained by reducing a silver salt in a dispersing agent in the presence of a dispersion stabilizer with a reducing agent differing therefrom, the dispersion stabilizer is selected from carboxylic acids having ≧1 to ≦6 carbon atoms, salts of carboxylic acids having ≧1 to ≦6 carbon atoms, sulfates and/or phosphates.

The inventive polymer material is suitable, in particular, for the production of polymer electrodes. The surface resistance of the material according to the invention in the unextended state can for example be ≧1 Ω/□ to ≦25 ohm/square or ≧1 Ω/□ to ≦5 Ω/□. It can be determined by reference to the standard ASTM D257-07.

In terms of the film thickness the specific surface resistance in the unextended state can for example be ≧0.0001 Ωcm to ≦0.01 Ωcm or ≧0.0002 Ωcm to ≦0.0005 Ωcm. It can be determined by reference to the standard ASTM D257-07.

The specific conductivity in the unextended state can for example be ≧300 S/cm to ≦6000 S/cm, ≧2000 S/cm to ≦5000 S/cm or ≧3000 S/cm to ≦4000 S/cm. It can be determined by reference to the standard ASTM D257-07.

The term “polymer” as used herein in meant to encompass prepolymers, which can be reacted with chain extenders to increase the molecular weight. The polymer is preferably, obtainable from a polymer dispersion.

Within the meaning of the present invention, “nanoparticles” are in particular particles having a d₅₀ value of less than 200 nm, preferably less than 100 nm, particularly preferably less than 60 nm; measured by dynamic light scattering. A ZetaPlus zeta potential analyzer from Brookhaven Instrument Corporation, for example, can be used for the measurement by dynamic light scattering. The particles are preferably spherical or approximately spherical.

Suitable silver salts as precursors of the silver nanoparticles may be, for example, acetates, nitrates, acetylacetonates, benzoates, bromates, bromides, carbonates, chlorides, citrates, fluorides, iodates, iodides, lactates, nitrites, perchlorates, phosphates, sulfates, sulfides and/or trifluoroacetates.

According to the invention, a dispersion stabilizer and a reducing agent differing therefrom are present in the production of the silver nanoparticles. This means that the dispersion stabilizer makes no contribution or only ah unsubstantial contribution to the reduction of the silver salts. This can be achieved by using a reducing agent whose redox potential is more strongly negative than the corresponding potential of the dispersion stabilizer and which is therefore preferred for thermodynamic reasons. A further route is by means of a kinetic inhibition, by using a reducing agent, which reacts more quickly than the dispersion stabilizer. The thermodynamic and kinetic aspects can be influenced by means of the relative proportions of dispersion stabilizer and reducing agent and by means of the chosen reaction temperature.

The salts of carboxylic acids, preferably of mono-, di- and tricarboxylic acids, can preferably be the alkali or ammonium salts, by preference the lithium, sodium, potassium or tetramethyl-, tetraethyl- or tetrapropylammonium salts.

If the cited carboxylic acids are used as dispersion stabilizers, they can be used together with amines to adjust the desired pH. Suitable amines are monoalkyl-, dialkyl- or dialkanolamines, such as for example diethanolamine.

Any excess of the electrostatic dispersion stabilizer(s) can be removed by means of known purification methods, such as for example diafiltration, reverse osmosis and membrane filtration.

The dispersion stabilizers do not stabilize the silver nanoparticles against an undesired aggregation by means of steric hindrance, as would be the case with polymeric dispersing agents. Instead, repulsive electrostatic forces act between the nanoparticles and counteract the attractive van der Waals forces, which encourage aggregation of the particles. As the surface of the particles is not covered with sterically acting stabilizers, the silver nanoparticles and materials produced from them can exhibit a higher electrical conductivity. The disadvantages mentioned hereinabove in regard to WO 2005/079353 A2 may be overcome in this way. A further important factor is that according to the invention the silver salt is reduced by a reducing agent which differs from the dispersion stabilizer, which is selected from carboxylic acids having ≧l to ≦6 carbon atoms, salts of carboxylic acids having ≧1 to ≦6 carbon atoms, sulfates arid/or phosphates. The selected dispersing agents, for example citric acid or a citrate, thus substantially bring about the dispersion rather than the reduction of the silver nanoparticles.

A further advantage of the silver nanoparticles obtained in this way is that a thermal conversion (known as annealing) to larger, also macroscopic, structures with correspondingly higher electrical conductivity can take place at much lower temperatures in comparison to conventionally obtained nanoparticles. Thus, this can take place at just 80° C. in comparison to over 200° C. for other nanoparticles.

Suitable reducing agents include, for example, thioureas, hydroxyacetone, boron hydrides, hydroquinone, ascorbic acid, dithionites, hydroxymethane sulfinic acid, disulfides, formamidine sulfinic acid, sulfuric acid, hydrazine, hydroxylamine, ethylenediamine, tetramethylenediamine and/or hydroxylamine sulfates. Boron hydrides and in particular sodium boron hydride are preferred here.

In one embodiment of the polymer material according to the invention, the silver nanoparticles in the dispersing agent used for production thereof in the presence of the dispersion stabilizer used for production thereof have a zeta potential in a pH range of ≧pH 2 to ≦pH 10 of ≦−5 mV to ≧−40 mV. The zeta potential is the electric potential at the shearing layer of a moving particle in a suspension. In other words, the zeta potential is the potential difference between the dispersion medium and the stationary fluid layer on the dispersed particle.

The level of this potential is dependent in principle on the dispersing agent surrounding the nanoparticles, in particular the ions contained in the dispersing agent, and in particular on the pH of the dispersing agent.

The zeta potential is measured by electrophoresis. Various instruments known to the person skilled in the art are suitable for this purpose, such as for example the ZetaPlus or ZetaPALS range from Brookhaven Instruments Corporation. The electrophoretic mobility of particles is measured by electrophoretic light scattering (ELS). The light scattered by the particles moving in the electric field undergoes a frequency change because of the Doppler effect, and this can be used to determine the migration rate. Phase analysis light scattering (PALS) (using ZetaPALS instruments, for example) can also be used to measure very small potentials or for measurements in non-polar media or at high salt concentrations.

Silver nanoparticles with such zeta potentials exhibit very good resistance to aggregation. As has already been described, they can be obtained by using the aforementioned dispersion stabilizers during reduction of the silver salts. The zeta potential, measured in water, in a pH range from ≧pH 6 to ≦pH 8 is preferably between ≦−25 mV and ≧−40 mV, particularly preferably between ≦−25 mV and ≧−35 mV.

As the aforementioned zeta potential is dependent on the liquid dispersing agent surrounding the silver nanoparticles, in particular on the pH of the dispersing agent, and as such a zeta potential is greatly reduced outside such a dispersion, the aforementioned repulsive electrostatic forces do not continue if the dispersing agent is removed, such that despite the outstanding resistance to aggregation of the silver nanoparticles in the dispersion, the subsequent conductivity of a material produced with the dispersion is not compromised or is only unsubstantially compromised.

In a further embodiment of the polymer material according to the invention, the dispersing agent in the production of the silver nanoparticles is selected from the group comprising water, alcohols having ≧1 to ≦4 carbon atoms, ethylene glycol, aldehydes having ≧1 to ≦4 carbon atoms and/or ketones having ≧3 to ≦4 carbon atoms. A preferred dispersing agent is water. Non-aqueous solvents such as acetone can be used for example if a polymer solution is to be mixed with the nanoparticles and the solvent then removed.

In a further embodiment of the polymer material according to the invention the dispersion stabilizer in the production of the silver nanoparticles is citric acid and/or citrate. Their use is advantageous because citric acid melts at 153° C. and breaks down at temperatures above 175° C. The dispersion stabilizer can be removed thermally from an end product in this way.

In the polymer material according to the invention, the polymer is preferably an elastomer.

If the polymer is an elastomer, extensible electrodes according to the invention can be produced such as can be used in electromechanical converters, in particular those based on polymers, preferably in turn those based on elastomers such as silicones, acrylics, polyurethanes, polystyrene, natural rubber, synthetic rubber, vulcanised rubber, gutta-percha or latex. Thus for example the acrylic elastomer VHB 4910 from 3 M, which withstands strains of up to 300%, can be used as the elastomer material.

Electromechanical converters are known for example from U.S. Pat. No. 5 977 685A. The electrodes of such converters have to adapt to changes in the length of the converter, as otherwise the electrodes would tear (particularly under strain) and/or separate (particularly under compression). In U.S. Pat. No. 6 583 533 B2 and U.S. Pat. No. 7 518 284 B2, for example, this was solved by applying corrugated electrodes, made from silver for example. The application of these electrodes is technically complex and expensive, however. In addition, the electrodes are also expensive because of the high silver usage. Using the polymer material according to the invention flexible and extensible electrodes can be produced which do not have these disadvantages. In a further, particularly preferred, embodiment of the polymer material according to the invention the polymer is a polyurethane. This term encompasses polyisocyanurates, allophanates and other reaction products of polyisocyanates and polyisocyanate prepolymers with polyols and/or polyamines. A preferred group of polyurethanes is polyurethane Cast elastomers. After being mixed with the silver nanoparticles, the elastomers can be thermally cured and at the same time the nanoparticles converted to larger units. A further preferred form of the polyurethane is if it forms aqueous emulsions and after drying can coalesce to form a film. In this way, mixtures of an aqueous polyurethane dispersion and an aqueous silver nanoparticle dispersion can be produced which can be applied to a substrate by spraying or by knife application, for example. Following removal of the water, a polymer material according to the invention is obtained.

Examples of polyurethanes which can be used according to the invention are aqueous polyurethane dispersions, for example hydroxy-functional polyurethane dispersions such as BAYHYDROL U, high-molecular-weight polyurethane dispersions (PUD) such as BAYHYDROL UH, polyurethane-polyacrylate hybrid dispersions (PUR-PAC dispersions), such as BAYHYDROL UA, polyurethane dispersions for textile coatings, such as IMPRANIL, preferably anionic aliphatic polyether urethane dispersions such as IMPRANIL 43032, IMPRANIL DLH, IMPRANIL DLN, IMPRANIL DLN-SD, IMPRANIL DLN W 50, IMPRANIL DLP, IMPRANIL LP RSC 3040 or IMPRANIL LP RSC 4002, anionic, aromatic polyether-polyurethane dispersions such as IMPRANIL XP 2745 or IMPRANIL XP 27, the various IMPRANIL variants being preferred because of their low viscosity and high elasticity. IMPRANIL LP DSB 1069 is preferred in particular.

In one embodiment of the invention, the polyurethane is obtained from a reaction mixture comprising the following components:

A) a polyisocyanate,

B) a polyisocyanate prepolymer

C) a compound haying at least two isocyanate-reactive hydroxyl groups.

1,4-Butylene diisocyanate, 1,6-hexamethylene diisocyanate (HDI), isophorone diisocyanate (IPDI), 2,2,4- and/or 2,4,4-trimethylhexamethylene diisocyanate, the isomeric bis-(4,4′-isocyanatocyclohexyl)methanes or mixtures thereof with any isomer content, 1,4-cyclohexylene diisocyanate, 4-isocyanatomethyl-1,8-octane diisocyanate (nonane triisocyanate), 1,4-phenylene diisocyanate, 2,4- and/or 2,6-toluylene diisocyanate, 1,5-naphthylene diisocyanate, 2,2′- and/or 2,4′- and/or 4,4′-diphenylmethane diisocyanate, 1,3- and/or 1,4-bis-(2-isocyanatoprop-2-yl)benzene (TMXDI), 1,3-bis(isocyanatomethyl)benzene (XDI), alkyl-2,6-diisocyanatohexanoates (lysine diisocyanates) with alkyl groups having 1 to 8 carbon atoms and mixtures thereof, for example, are suitable as the polyisocyanate and component A). Furthermore, compounds containing uretdione, isocyanurate, biuret, iminooxadiazinedione or oxadiazinetrione structures and based on the cited diisocyanates are suitable structural units of component A).

In one embodiment, component A) can be a polyisocyanate or a polyisocyanate mixture having an average NCO functionality of 2 to 4 with exclusively aliphatically or cycloaliphatically bonded isocyanate groups. These are preferably polyisocyanates or polyisocyanate mixtures of the aforementioned type having a uretdione, isocyanurate, biuret, iminooxadiazinedione or oxadiazinetrione structure as well as mixtures thereof and an average NCO functionality of the mixture of preferably 2 to 4, more preferably 2 to 2.6 and most preferably 2 to 2.4.

Polyisocyanates based on hexamethylene diisocyanate, isophorone diisocyanate or the isomeric bis-(4,4′-isocyanatocyclohexyl)methanes and mixtures of the aforementioned diisocyanates can particularly preferably be used as component A).

The polyisocyanate prepolymers which can be used as component B) can be obtained by reacting one or more diisocyanates with one or more hydroxy-functional, in particular polymeric, polyols, optionally with the addition of catalysts as well as auxiliary substances and additives. Furthermore, components for chain extension, such as for example those having primary and/or secondary amino groups (NH₂- and/or NH-functional components), can additionally be used for the formation of the polyisocyanate prepolymer.

The polyisocyanate prepolymer as component B) can preferably be obtained from the reaction of polymeric polyols and aliphatic diisocyanates. Polyisocyanate prepolymers based on polypropylene glycol as the polyol and hexamethylene diisocyanate as the aliphatic diisocyanate are preferred as component B).

Hydroxy-functional, polymeric polyols for the reaction to form the polyisocyanate prepolymer B) can include for example polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and/or polyester polycarbonate polyols. These can be used individually or in any mixtures with one another to produce the polyisocyanate prepolymer.

Suitable polyester polyols for producing the polyisocyanate prepolymers B) include polycondensates of diols and optionally triols and tetraols and dicarboxylic and optionally tricarboxylic and tetracarboxylic acids or hydroxycarboxylic acids or lactones. In place of the free polycarboxylic acids, the corresponding polycarboxylic anhydrides or corresponding polycarboxylic acid esters of low alcohols can also be used to produce the polyesters.

Examples of suitable diols include ethylene glycol, butylene glycol, diethylene glycol, triethylene glycol, polyalkylene glycols such as polyethylene glycol, also 1,2-propanediol, 1,3-propanediol, butanediol(1,3), butanediol(1,4), hexanediol(1,6) and isomers, neopentyl glycol or hydroxypivalic acid neopentyl glycol ester or mixtures thereof, with hexanediol(1,6) and isomers, butanediol(1,4), neopentyl glycol and hydroxypivalic acid neopentyl glycol ester being preferred. In addition, polyols such as trimethylolpropane, glycerol, erythritol, pentaerythritol, trimethylolbenzene or tris-hydroxyethyl isocyanurate or mixtures thereof can also be used.

Phthalic acid, isophthalic acid, terephthalic acid, tetrahydrophthalic acid, hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid and/or 2,2-dimethyl succinic acid can be used here as dicarboxylic acids. The corresponding anhydrides may also be used as the acid source.

Provided that the average functionality of the polyol to be esterified is ≧2, monocarboxylic acids, such as benzoic acid and hexanecarboxylic acid, may additionally be incorporated.

Preferred acids are aliphatic or aromatic acids of the aforementioned type. Adipic acid, isophthalic acid and phthalic acid are particularly preferred.

Hydroxycarboxylic acids which can be incorporated as reactants in the production of a polyester polyol having terminal hydroxyl groups are, for example, hydroxycaproic acid, hydroxybutyric acid, hydroxydecanoic acid or hydroxystcaric acid or mixtures thereof. Suitable lactones are caprolactone, butyrolactone or homologues or mixtures thereof. Caprolactone is particularly preferred.

Polycarbonates containing hydroxyl groups, for example polycarbonate polyols, preferably polycarbonate diols, can likewise be used to produce the polyisocyanate prepolymers B). They can have a number-average molecular weight Mₙ of 400 g/mol to 8000 g/mol, for example, preferably 600 g/mol to 3000 g/mol. They can be obtained by reacting carbonic acid derivatives, such as diphenyl carbonate, dimethyl carbonate or phosgene, with polyols, preferably diols.

Examples of diols which are suitable for this purpose are ethylene glycol, 1,2- and 1,3-propanediol, 1,3-and 1,4-butanediol, 1,6-hexanediol, 1,8-octanediol, neopentyl glycol, 1,4-bishydroxymethyl cyclohexane, 2-methyl-1,3-propanediol, 2,2,4-trimethylpentanediol-1,3, dipropylene glycol, polypropylene glycols, dibutylene glycol, polybutylene glycols, bisphenol A or lactone-modified diols of the aforementioned type or mixtures thereof.

The diol component preferably contains from 40 percent by weight to 100 percent by weight of hexanediol, preferably 1,6-hexanediol and/or hexanediol derivatives. Such hexanediol derivatives are based on hexanediol and can have ester or ether groups in addition to terminal OH groups. Such derivatives are obtainable for example by reacting hexanediol with excess caprolactone or by etherifying hexanediol with itself to form dihexylene or trihexylene glycol. In the context of the present invention the amounts of these and other components are chosen in a known manner such that the sum does not exceed 100 percent by weight and in particular adds to 100 percent by weight.

Polycarbonates having hydroxyl groups, in particular polycarbonate polyols, preferably have a linear structure.

Polyether polyols can likewise be used to produce the polyisocyanate prepolymers B). Polytetramethylene glycol polyethers such as are obtained by polymerization of tetrahydrofuran by cationic ring opening are suitable, for example. Likewise suitable polyether polyols can be the addition products of styrene oxide, ethylene oxide, propylene oxide, butylene oxide and/or epichlorohydrin with difunctional or polyfunctional starter molecules. Water, butyl diglycol, glycerol, diethylene glycol, trimethylolpropane, propylene glycol, sorbitol, ethylene diamine, triethanolamine or 1,4-butanediol or mixtures thereof, for example, can be used as suitable starter molecules.

Preferred components for producing the polyisocyanate prepolymers B) are polypropylene glycol, polytetramethylene glycol polyethers and polycarbonate polyols or mixtures thereof, polypropylene glycol being particularly preferred.

Polymeric polyols having a number-average molecular weight Mₙ of preferably 400 g/mol to 8000 g/mol, more preferably 400 g/mol to 6000 g/mol and most preferably 600 g/mol to 3000 g/mol can be used in the present invention. These preferably have an OH functionality of 1.5 to 6, particularly preferably 1.8 to 3, most particularly preferably 1.9 to 2.1.

In addition to the cited polymeric polyols, short-chain polyols may also be used in the production of the polyisocyanate prepolymers B). For example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, trimethylolethane, glycerol or pentaerythritol or a mixture thereof can be used.

Ester diols of the cited molecular weight range such as α-hydroxybutyl-ε-hydroxyhexanoic acid ester, ω-hydroxyhexyl-γ-hydroxybutyric acid ester, adipic acid-(β-hydroxyethyl) ester or terephthalic acid-bis(β-hydroxyethyl) ester are also suitable.

Monofunctional isocyanate-reactive hydroxyl-group-containing compounds may also be used to produce the polyisocyanate prepolymers B). Examples of such monofunctional compounds include ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol or 1-hexadecanol or mixtures thereof.

To produce the polyisocyanate prepolymers B) diisocyanates may preferably be reacted with the polyols in a ratio of isocyanate groups to hydroxyl groups (NCO/OH ratio) of 2:1 to. 20:1, for example 8:1. Urethane and/or allophanate structures may be formed in this process. A proportion of unreacted polyisocyanates may be separated off subsequently. A film distillation process may be used to this end, for example, wherein low-residual-monomer products having residual monomer contents of for example ≦1 percent by weight, preferably ≦0.5 percent by weight, particularly preferably ≦0.1 percent by weight, are obtained. The reaction temperature may preferably be from 20°0 C. to 120° C., more preferably from 60° C. to 100° C. Stabilizers such as benzoyl chloride, isophthaloyl chloride, dibutyl phosphate, 3-chloropropionic acid or methyl tosylate may optionally be added during production.

Furthermore, NH₂- and/or NH-functional components may additionally be used for chain extension during production of the polyisocyanate prepolymers B).

Suitable components for chain extension include organic diamines or polyamines. For example, ethylene diamine, 1,2-diaminopropane, 1,3-diaminopropane, 1,4-diaminobutane, 1,6-diaminohexane, isophorone diamine, a mixture of isomers of 2,2,4- and 2,4,4-trimethyl hexamethylene diamine, 2-methyl pentamethylene diamine, diethylene triamine, diaminodicyclohexyl methane or dimethyl ethylene diamine or mixtures thereof can be used.

Moreover, compounds which in addition to a primary amino group also have secondary amino groups or which in addition to an amino group (primary or secondary), also have OH groups, can also be used to produce the polyisocyanate prepolymers B). Examples include primary/secondary amines such as diethanolamine, 3-amino-1-methylaminopropane, 3-amino-1-ethylaminopropane, 3-amino-1-cyclohexylaminopropane, 3-amino-1-methylaminobutane, alkanol amines such as N-aminoethyl ethanolamine, ethanolamine, 3-aminopropanol, neopentanolamine. Amines having an isocyanate-reactive group, such as methylamine, ethylamine, propylamine, butylamine, octylamine, laurylamine, stearylamine, isononyl oxypropylamine, dimethylamine, diethylamine, dipropylamine, dibutylamine, N-methylaminopropylamine, diethyl(methyl)amino-propylamine, morpholine, piperidine, or suitable substituted derivatives thereof, amidoamines of diprimary amines and monocarboxylic acids, monoketimes of diprimary amines, primary/tertiary amines, such as N,N-dimethylamino-propylamine, are conventionally used for chain termination.

The polyisocyanate prepolymers or mixtures thereof used as component B) may preferably have an average. NCO functionality of preferably 1.8 to 5, more preferably 2 to 3.5, and most preferably 2 to 2.5.

Component C) is a compound having at least two isocyanate-reactive hydroxyl groups. For example component C) can be a polyamine or a polyol having at least two isocyanate-reactive hydroxyl groups.

Hydroxy-functional, in particular polymeric, polyols, for example polyether polyols, may be used as component G). Polytetramethylene glycol polyethers, such as are obtained by polymerization of tetrahydrofuran by cationic ring opening, are suitable for example. Likewise, suitable polyether polyols may be the addition products of styrene oxide, ethylene oxide, propylene oxide, butylene oxide and/or epichlorohydrin with difunctional or polyfunctional starter molecules. Water, butyl diglycol, glycerol, diethylene glycol, trimethylolpropane, propylene glycol, sorbitol, ethylene diamine, triethanolamine or 1,4-butanediol or mixtures thereof, for example, may be used as suitable starter molecules.

It is preferable for component C) to be a polymer having 2 to 4 hydroxyl groups per molecule, most preferably, a polypropylene glycol haying 2 to 3 hydroxyl groups per molecule.

According to the invention, the polymeric, polyols from C) preferably have a particularly harrow molecular weight distribution, in Other words a polydispersity (PD=Mw/Mn) of 1.0 to 1.5 and/or an OH functionality of greater than 1.9. The cited polyether polyols preferably have a polydispersity of 1.0 to 1.5 and an OH functionality of greater than 1.9, particularly preferably greater than or equal to 1.95.

Such polyether, polyols can be produced in a manner known per se by alkoxylation of suitable starter molecules, in particular using double metal cyanide catalysts (DMC catalysis). This method is described for example in the patent U.S. Pat. No. 5,158,922 and in the laid-open patent application EPO 654 302 A1.

The reaction mixture for the polyurethane can be obtained by mixing components A), B) and C). The ratio of isocyanate-reactive hydroxyl groups to free isocyanate groups here is preferably from 1:1.5 to 1.5:1, particularly preferably from 1:1.02 to 1:0.95.

At least one of components A), B) or C) preferably has a functionality of ≧2.0, more preferably ≧2.5, most preferably ≧3.0, to introduce a branching or crosslinking into the polymer element. The term “functionality” as used herein refers in components A) and B) to the average number of NCO groups per molecule and in component C) to the average number of OH groups per molecule. This branching or crosslinking brings about better mechanical properties and better elastomeric properties, in particular, also better strain properties.

The polyurethane can advantageously have good mechanical strength and high elasticity. In particular, the polyurethane can have a maximum stress of preferably ≧0.2 MPa, more preferably 0.4 MPa to 50 MPa, and a maximum strain of preferably ≧250%, more preferably ≧350%. In the working strain range of 50% to 200%, the polyurethane can moreover have a stress of preferably 0.1 MPa to 1 MPa, more preferably 0.1 MPa to 0.8 MPa, most preferably 0.1 MPa to 0.3 MPa (determined in accordance with DIN 53504). Furthermore, the polyurethane can have an elasticity modulus at a strain of 100% of preferably 0.1 MPa to 10 MPa, more preferably 0.2 MPa to 5 MPa (determined in accordance with DIN EN 150 672 1-1).

In addition, the polyurethane can advantageously have good electrical properties; these can be determined in accordance with ASTM D 149 for the disruptive strength and in accordance with ASTM D 150 for the dielectric constant measurements.

In addition to components A), B) and C), the reaction mixture can additionally also contain auxiliary substances and additives as known to those skilled in the art. Examples of such auxiliary substances and additives include crosslinkers, thickeners, co-solvents, thixotropic agents, stabilizers, antioxidants, light stabilizers, emulsifiers, surfactants, adhesives, plasticizers, hydrophobing agents, pigments, fillers and flow control agents. In a further embodiment of the polymer material according to the invention, the weight ratio of polymer to silver nanoparticles is ≧10:90 to ≦50:50. The ratio can also be in a range from ≧20:80 to ≦30:70. Without being limited to any one theory, it is assumed that with such weight contents the percolation threshold for the silver nanoparticles is exceeded by some way without haying to use excessive amounts of material.

The present invention relates furthermore to a method for producing a polymer material which comprises a polymer and silver nanoparticles dissolved in the polymer, wherein me method comprises the following steps:
Provision of a polymer;
Provision of silver nanoparticles, which can be obtained by reducing a silver salt in a dispersing agent in the presence of a dispersion stabilizer with a reducing agent differing therefrom, the dispersion stabilizer being selected from carboxylic acids having ≧1 to ≦6 carbon atoms, salts of carboxylic acids having ≧1 to ≦6 carbon atoms, sulfates and/or phosphates; and
Mixing of the polymer and the silver nanoparticles.

Details of the components have already been described in connection with the polymer material according to the invention, reference to which is made in order to avoid repetition.

In one embodiment of the method according to the invention the silver nanoparticles in the dispersing agent used for production thereof in the presence of the dispersion stabilizer used for production thereof have a zeta potential in a pH range of ≧pH 2 to ≦pH 10 of ≦−5 mV to ≧−40 mV. Details thereof have already been described above.

In a further embodiment of the method according to the invention, the dispersion stabilizer in the production of the silver nanoparticles is citric acid and/or citrate. Details thereof have already been described above.

In a further embodiment of the method according to the invention, the polymer is an elastomer, preferably a silicone, acrylic, polyurethane, polystyrene, natural rubber, synthetic rubber, vulcanized rubber, gutta-percha or latex. Details thereof have already been described above.

In a further embodiment of the method according to the invention, the polymer and the silver nanoparticles are dispersed in a dispersing agent. Two liquid phases can then be mixed together. This results in a homogeneous dispersion of the silver nanoparticles.

Advantageously the dispersing agents for the polymer and for the silver nanoparticles may selected independently of one another from the group comprising water, alcohols having ≧1 to ≦4 carbon atoms, ethylene glycol, aldehydes having ≧1 to ≦4 carbon atoms and/or ketones having ≧3 to ≦4 carbon atoms. As already mentioned above, it is preferable for water to be the common dispersing agent.

In a further embodiment of the method according to the invention, it further comprises the step of heating the mixture obtained, comprising polymer and silver nanoparticles, to a temperature of preferably ≧30° C. to ≦180° C. This temperature is more preferably ≧50° C. to ≦150° C. and most preferably ≧80° C. to ≦100° C. As already mentioned, at such low temperatures the silver nanoparticles used can be converted to larger and electrically even more conductive structures. Furthermore, a film obtained from a polymer dispersion can then be dried at the same time or a cast elastomer cured.

The polymer material according to the invention may be used, in particular, as a flexible and/or extensible electrode. The present invention therefore also provides an extensible and/or flexible electrode comprising the polymer material according to the invention.

Conceivable applications of the polymer material according to the invention and of the extensible and/or flexible electrodes containing it lie in particular in the area of electromechanical converters. The present invention therefore also provides a polymer laminar composite comprising a polymer substrate and a polymer material according to the invention. The material of the polymer substrate is preferably a dielectric elastomer; the polymer substrate is particularly preferably flexible. It is further preferable for the polymer substrate to be provided with the polymer material according to the invention on two opposite sides. The polymer material may be applied to the polymer substrate by knife application, gravure printing, spraying, dipping, screen printing. In order for the polymer material according to the invention to adhere better to the polymer material, water and/or a surfactant for example may be added to it.

This is preferably followed by a sintering process; this can be carried out by means of thermal or photonic sintering.

Such a method has already been described in US 20080020304 A1. The mechanism of photonic sintering is based on the fact that metallic nanoparticles, unlike the polymer substrate, absorb photonic radiation and thus energy very strongly, leading to sintering of the nanoparticles at low temperatures. As the nanoparticles have a lower tendency towards reflection and towards thermal conductivity, the polymer matrix, which can scarcely adsorb photonic radiation, is not damaged by this process. Pulsed photonic sources, which heat the particles to high temperatures in a very short time, have proved to be particularly advantageous. These can be gamma or X-ray radiation or ultraviolet, visible, infrared light or microwaves, radio waves or a combination of the various forms of radiation.

The polymer material according to the invention can be at least partially in contact with the polymer substrate. It is however also possible for further layers, such as for example adhesive layers, to be present between the polymer substrate and the polymer material.

### Example 1

### Production of a Silver Nanoparticle Dispersion

1 liter of distilled water was placed in a flask with a capacity of 2 liters. Then 100 ml of a 0.7 wt. % aqueous solution of trisodium citrate followed by 200 ml of a 0.2 wt. % aqueous solution of sodium boron hydride were added whilst stirring. A 0.045 molar aqueous solution of silver nitrate was added to the mixture obtained over a period of 1 hour at a volumetric flow rate of 0.2 1/hour whilst stirring. A dispersion of silver nanoparticles formed during this process. This was purified and concentrated by diafiltration.

For the purposes of characterization the resulting dispersion was diluted with water in a ratio of 1:200 and in seven samples the pH was adjusted with concentrated NaOH solution. Zeta potentials were determined for various pH values. The pH and in brackets the zeta potential in mV are given:

pH 10 (−43.9 mV); pH 8.8 (−34.2 mV); pH 7.5 (−38.3 mV); pH 6.3 (−29.1 mV); pH 4.9 (−23.3 mV); pH 2.4 (−23.7 mV)

All measurements of the samples were performed three times arid a resulting standard deviation of ±0.5 was determined. The zeta potential was measured using a Brookhaven Instruments Corporation 90 Plus instrument with ZetaPlus particle sizing software version 3.59. The measurements were performed in a dispersion with a solids content Of 0.05 wt % relative to the total weight of the sample to be measured.

### Example 2

### Production of a Polymer Material According to the Invention and Coating of a Substrate

10 g of a silver nanoparticle dispersion according to Example 1 (solids content: 17 wt. % in water) were mixed with 2 g of an aqueous polyurethane dispersion (solids content: 50 wt. % in water) in a round flask. 1 g of an additive blend was also added (additive blend formulation: 40 g water, 0.3 g TRITON-X (non-ionic surfactant, octylphenol ethoxylate) and 0.2 g hydroxyethyl cellulose). The relative solids contents were 37% polyurethane and 63% silver nanoparticles. The mixture was stirred for 1 hour at room temperature and then treated for 30 minutes in an ultrasonic bath. A dielectric polyurethane elastomer was selected as the substrate to be coated. The/mixture was applied to the substrate in a wet film thickness of 75 μm using a knife. The coated sample was then dried for 30 minutes at 80° C. in an oven. The film thickness was measured at 1.1 μm using a profilometer.

Using an SD-600 four-point measurement setup from NAGY Mess-System, the surface resistance of the unextended sample was, measured in accordance with ASTM D257-07, giving a value of 21 Ω/□. The calculated specific surface resistance relative to the measured film thickness was 0.00234 Ωcm and the specific conductivity was 428 S/cm.

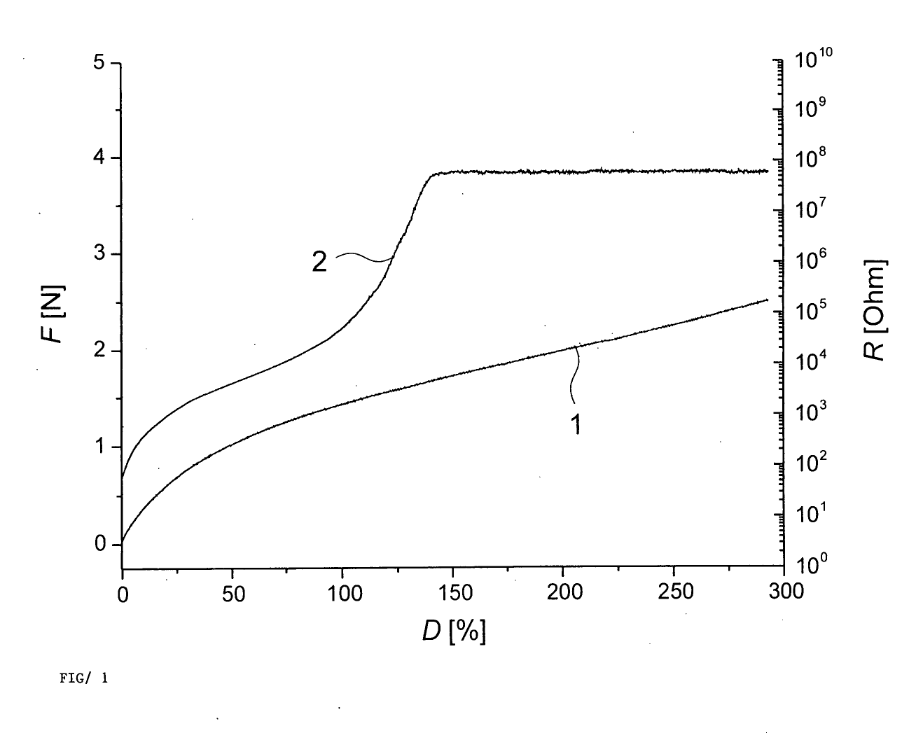

The flexibility of the laminar composite obtained was tested in a stress-strain measurement as shown in FIG. 1. Here curve 1 shows the change in force F with increasing strain D. Curve 2 shows the corresponding change in electrical resistance R as a function of the strain D.

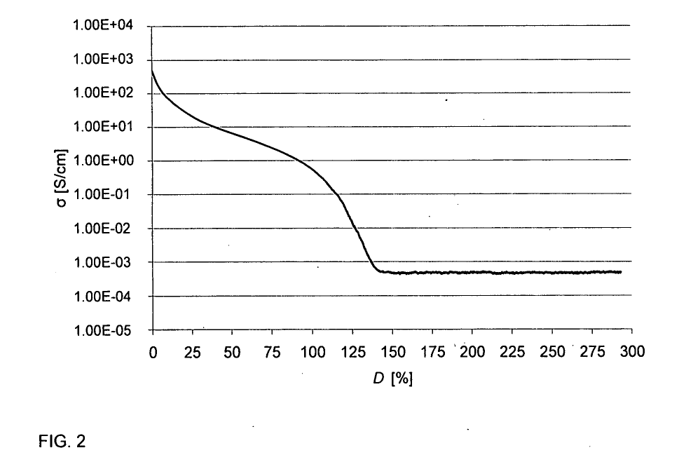

FIG. 2 shows the specific conductivity σ function of the strain D. It is pointed out by way of example that up to a strain of approx. 90% a specific conductivity of 1 S/cm or more is achieved.

### Example 3

### Production of a Polymer Material According to the Invention and Coating of a Substrate

9.1 g of a silver nanoparticle dispersion according to Example 1 (solids content: 17 wt. % in water) were mixed with 0.9 g of an aqueous polyurethane dispersion (solids content: 50 wt. % in water) in a round flask. 0.4 g of an additive blend (additive blend formulation: 40 g water, 0.3 g TRITON-X (non-ionic surfactant, octylphenol ethoxylate) and 0.2 g hydroxyethyl cellulose) and 0.08 g of ethylene glycol were also added. The relative solids contents were 22% polyurethane and 77% silver nanoparticles. The mixture was stirred for 1 hour at room temperature and then treated for 30 minutes in an ultrasonic bath. A dielectric polyurethane elastomer was selected as the substrate to be coated. The mixture was applied to the substrate three times in succession using a spray gun with a 0.3 mm nozzle attachment under 2 mbar pressure. The coated sample was then dried for 2 hours at 80° C. in an oven. The film thickness was measured at 3 μum using a profilometer.

Using a four-point measurement setup, the surface resistance of the unextended sample was measured in accordance with ASTM D257-07, giving a value of 1.75 Ω/□. The calculated specific surface resistance relative to the measured film thickness was 0.0002 Ωcm and the specific conductivity was 5714 S/cm.

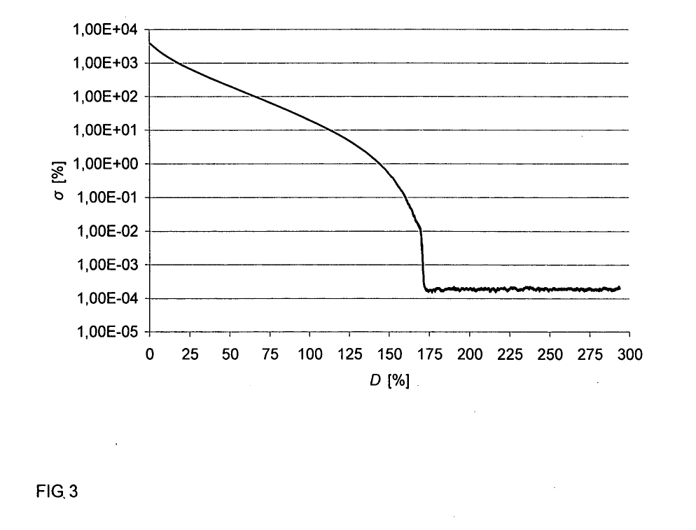

FIG. 3 shows the specific conductivity a as a function of the strain D. It is pointed out by way of example that up to a strain of approx. 140% a specific conductivity of 1 S/cm or more is achieved.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polymer material comprising a polymer and silver nanoparticles dispersed in the polymer, wherein the weight ratio of polymer material to silver nanoparticles is in a range from ≧10:90 to ≦50:50.

2. The polymer material according to claim 1, wherein the silver nanoparticles are obtained by reducing a silver salt in a dispersing agent in the presence of a dispersion stabilizer with a reducing agent differing therefrom, the dispersion stabilizer being selected from the group consisting of carboxylic acids having ≧1 to ≦6 carbon atoms;, salts of carboxylic acids having ≧1 to ≦6 carbon atoms, sulfates and phosphates.

3. The polymer material according to claim 2, wherein the silver nanoparticles in the dispersing agent have a zeta potential in a pH range of ≧pH 2 to ≦pH 10 of ≦−5 mV to ≧−40 mV.

4. The polymer material according to claim 2, wherein the dispersing agent in the production of the silver nanoparticles is selected from the group consisting of water, alcohols having ≧1 to ≦4 carbon atoms, ethylene glycol, aldehydes having ≧1 to ≦4 carbon atoms arid ketones having ≧3 to ≦4 carbon atoms.

5. The polymer material according to claim 2, wherein the dispersion stabilizer is citric acid arid/or citrate.

6. The polymer material according to claim 1, wherein the polymer is an elastomer selected from the group consisting of polyurethane, silicone, acrylic, polystyrene, natural rubber, synthetic rubber, vulcanized rubber, gutta-percha or latex.

7. A method for producing a polymer material comprising a polymer and silver nanoparticles dissolved in the polymer, the method comprising:
providing a polymer;
providing silver nanoparticles obtained by reducing a silver salt in a dispersing agent in the presence of a dispersion stabilizer with a reducing agent differing therefrom, the dispersion stabilizer being selected from the group consisting of carboxylic acids having ≧1 to ≦6 carbon atoms, salts of carboxylic acids having ≧1 to ≦6 carbon atoms, sulfates and/or phosphates; and
mixing the polymer and the silver nanoparticles to produce the polymer material.

8. The method according to claim 7, wherein the silver nanoparticles have a zeta potential in a pH range of ≧pH 2 to ≦pH 10 of ≦−5 mV to ≧−40 mV.

9. The method according to claim 7, wherein the dispersion stabilizer is citric acid and/or citrate.

10. The method according to claim 7, wherein the polymer is an elastomer selected from the group Consisting of polyurethane, silicone, acrylic, polystyrene, natural rubber, synthetic rubber; vulcanized rubber, gutta-percha or latex.

11. The method according to claim 7, wherein the polymer and the silver nanoparticles are dispersed in a dispersing agent.

12. The method according to claim 11, wherein the dispersing agents for the polymer and for the silver nanoparticles are selected independently of one another from the group consisting water, alcohols having ≧1 to ≦4 carbon atoms, ethylene glycol, aldehydes having ≧1 to ≦4 carbon atoms and ketones having ≧3 to ≦4 carbon atoms.

13. The method according to claim 7, further including heating the mixture to a temperature of ≧30° C. to ≦180° C.

14. An extensible and/or flexible electrode comprising the polymer material according to claim 1.

15. A polymer laminar composite comprising a polymer substrate and the polymer material according to claim 1.
